(19) United States
(12) Patent Application Publication
(10) Pub. No.: US 2016/0315363 A1
(43) Pub. Date: Oct. 27, 2016

(54) DEVICE AND METHOD FOR MONITORING AN ENERGY STORE AND ENERGY STORE HAVING THE DEVICE

(71) Applicant: ROBERT BOSCH GMBH, Stuttgart (DE)

(72) Inventor: Gholamabas Esteghlal, Stuttgart-Weilimdorf (DE)

(21) Appl. No.: 15/104,276

(22) PCT Filed: Dec. 1, 2014
(86) PCT No.: PCT/EP2014/076084

§ 371 Date: Jun. 14, 2016

(30) Foreign Application Priority Data
Dec. 17, 2013 (DE) 10 2013 226 145.4

(51) Int. Cl. H01M 10/633; B60L 11/18; H01M 10/6568; H01M 10/48; H01M 10/625

(52) U.S. Cl. CPC H01M 10/633; H01M 10/486; H01M 10/482; H01M 10/625; H01M 10/6568; B60L 11/1874; H01M 2220/20; B60L 2200/10; B60L 2200/12; B60L 2200/32

(57) ABSTRACT

The invention relates to a device (710, 720, 730, 740) for monitoring an energy store (20; 30) comprising a plurality of battery cells (500₁₁₁₁-500ₖₗₘₙ), which are arranged in a plurality of battery groups (200₁-200ₖ, 300₁₁-300ₖₗ, 400₁₁₁-400ₖₗₘ), and a temperature-control device for controlling the temperature of the battery cells (500₁₁₁₁-500ₖₗₘₙ) by means of a plurality of partial flows of a temperature-control medium, each of the partial flows being associated with one of the battery groups (200₁-200ₖ, 300₁₁-300ₖₗ, 400₁₁₁-400ₖₗₘₙ), characterized by: a plurality of sensor apparatuses (720) for sensing temperature measurement values of the battery cells (500₁₁₁₁-500ₖₗₘₙ), each of the sensor apparatuses (720) being arranged in such a way that the sensor apparatus can sense the temperature measurement value of one of the battery cells (500₁₁₁₁-500ₖₗₘₙ); an apparatus (710, 740) for determining a plurality of average temperature values from the sensed temperature measurement values, each of the determined average temperature values being determined in such a way that the determined average temperature value is associated with one of the battery groups (200₁-200ₖ, 300₁₁-300ₖₗ, 400₁₁₁₋400ₖₗₘₙ); and an apparatus (740) for evaluating the plurality of determined average temperature values and, if one of the determined average temperature values exceeds a temperature threshold value, determining that the partial flow associated with the associated battery group (200₁-200ₖ, 300₁₁-300ₖₗ, 400₁₁₁-400ₖₗₘ) has a fault. The invention further relates to a battery system, a vehicle, a method, a computer program, and a computer program product.

### BACKGROUND OF THE INVENTION

The invention relates to a device and method for monitoring an energy store or respectively battery system as well as to an energy store having the device. The invention further relates to a vehicle, in particular a motor vehicle such as an electric vehicle or hybrid vehicle having the energy store.

It is foreseeable that new battery systems, for example comprising lithium-ion batteries or nickel-metal hydride batteries, will increasingly be used in stationary applications, for example in wind turbines, in industry or in domestic engineering as well as in mobile applications, for example in electric vehicles (EV) or hybrid vehicles (hybrid electric vehicles HEV) as rechargeable energy stores.

The battery systems have to meet very high requirements with regard to available energy content, charging and discharging efficiency, reliability, service life and with regard to undesirable loss of capacity due to frequent partial discharge.

A battery system or respectively an energy store comprises a plurality of battery cells. The battery cells heat up during charging and discharging due to their cell internal resistance and the electrochemical processes taking place. The battery cells can be connected in series in order to increase the electrical voltage and/or in parallel in order to increase the maximum electrical current. In so doing, the battery cells can be consolidated into battery units or battery modules. The battery module holds the battery cells and absorbs mechanical stresses so that the battery cells are protected from being damaged. The battery module can furthermore provide a mechanical bracing of the battery cells and an electric insulation. In addition, the battery module can be used for the temperature control of the battery cells.

FIG. 1 shows a schematic view of an energy store 10 according to the prior art, which, for example, can be used for a stationary application. The energy store or respectively the battery system 10 comprises a plurality of battery cells 500₁₁₁₁ to 500ₖₗₘₙ. The plurality of battery cells 500₁₁₁₁ to 500ₖₗₘₙ is arranged in a plurality of battery modules 400₁₁₁ to 400ₖₗₘ, so that each battery cell comprises n battery cells. The plurality of battery modules 400₁₁₁ to 400ₖₗₘ is arranged in a plurality of battery strings 300₁₁ to 300ₖₗ, so that each battery string comprises m battery modules. The plurality of battery strings 300₁₁ to 300ₖₗ is arranged in a plurality of partial batteries 200₁ to 200ₖ, so that each partial battery I comprises battery strings. The plurality of partial batteries 200₁ to 200ₖ is arranged as a battery 100, so that the battery k comprises partial batteries. The battery 100 comprises lines 110₁, 110₂ for connecting the partial batteries 200₁ to 200ₖ, so that the electrical energy is available at the connections 120₁, 120₂.

The temperature range for the operation of the battery cells lies typically between 0° C. and +40° C., preferably between +25° C. and +35° C. The performance of the battery cells can drop significantly in the lower range of the operating temperature. The internal resistance of the battery cells increases considerably at temperatures under approximately 0° C., and the performance and the degree of efficiency of the battery cells drop continuously when temperatures continue to fall. As a result, irreversible damage to the battery cells can also occur. If the operating temperature is exceeded, the performance of the battery cells can also drop significantly. The service life of the battery cells is reduced at temperatures above approximately 40° C. As a result, irreversible damage to the battery cells can likewise occur. Furthermore, the temperature difference (temperature gradient), which is admissible for the operation of the battery cells, in a battery cell and/or within a battery module or a battery typically lies between 5 Kelvin and 10 Kelvin. In the case of larger temperature gradients, different regions of a battery cell or different battery cells of a battery module or a battery can experience different stresses or even be (partially) overloaded and/or damaged. In addition, a danger of condensation forming in the battery exists due to temperature gradients and/or temperature changes. The damage can lead to an accelerated ageing of the battery cells or to a thermal runaway of the battery cells, which presents a danger for humans and the environment.

A battery system in which, for example, approximately 100 battery cells are wired in series or respectively parallel, can be used as a traction battery for driving vehicles. In the case of a high-voltage battery system, the total voltage can thus, for example, be 450 V or 600 V.

In a hybrid drive train of a vehicle, lithium-ion high performance battery cells having very high dynamics are operated. During short-term peak loads, which, for example, arise as a result of recuperation of brake energy during braking or boost support when accelerating, the battery cells have to consume a large amount of power (during charging) or deliver a large amount of power (during discharge) in a very short amount of time. These short peak loads cause the battery cells to heat up significantly due to the internal resistance of the battery cells. The degree of efficiency of the battery cells during charging or discharging is very high (approximately 95%). Nevertheless, the resulting waste heat is not insignificant. A loss of 5% results in a power loss of 3 KW for a traction output of, for example, 60 KW. In addition, outside temperatures which amount to 40° C. and more can, for example during the summer months or in warmer regions, lie outside of the admissible temperature range, so that the battery cells cannot reach a service life of, for example, ten years.

In order to ensure the dependability, function and service life of the battery module or respectively battery system, it is therefore necessary to operate the battery cells within the predefined temperature range. On the one hand, heat arises, as described above, during the operation of the battery cells, which has to be removed, in order to prevent the battery cells from heating up above the critical maximum temperature. On the other hand, it may be necessary to heat up the battery cells to a minimum temperature in the case of very low temperatures. In order to adhere to the predefined temperature range, the battery module or respectively battery system is temperature-controlled, i.e cooled or heated according to need.

To this end, the battery module or respectively battery system can comprise a fluid, for example a liquid such as alcohol, for example, propane-1,2,3-triol (glycerol, glycerin), oil or water, for example, salt water or a liquid mixture, as a temperature-control medium, for example coolant in a temperature-control medium circuit.

The cooling of the battery cells can, for example, be achieved by cooling plates, on which the battery cells are mounted. In the cooling plates, either a cooling agent such as coolant (air-heat radiator) or a refrigerant, which evaporates due to the heat (evaporator), absorbs the heat of the battery cells and discharges said heat via a radiator to the surrounding environment or to an air conditioning system (AC). Besides the cooling plates or the evaporator and the radiator, a cooling system further comprises tubes and/or pipes, for example made from plastic or metal such as aluminum, for connecting the cooling plates, the evaporator and/or the radiator. The cooling system can furthermore comprise a device for shutting off and/or controlling the flow of the temperature-control medium, for example a shut-off device such as a shut-off cock, a shut-off valve or a shut-off slide, or a valve like a manually actuated valve, an electromotively actuated valve or an electromagnetically actuated valve. The cooling system can furthermore comprise a flow sensor, for example an oval wheel meter, roller or piston type flow meter, impeller flow meter, magnetically inductive flow sensor, inductive flow sensor, ultrasonic flow sensor or Coriolis mass flow sensor, for detecting defects or faults of the cooling system, such as blockages, defects or faults of the shut-off device or respectively control device, or leakages which lead to an interruption of the temperature-control medium flow.

The European Patent Office application EP 1 309 029 A2 discloses a method and a device for controlling the cooling and detection of abnormalities in a battery pack system which comprises a plurality of battery pack blocks, which are connected to one another in series, in parallel or via a combination consisting of a series circuit and a parallel circuit, wherein each of the battery pack blocks is formed by connecting a plurality of cells in series, and each battery pack block contains a cooling unit for providing an air flow in the associated battery pack block, and a cooling mode of a battery pack block is changed if a difference in the state of charge between the battery pack block and another battery pack block exceeds a threshold value.

In order to increase the fail-safe stability, reliability and the disposability of battery systems and to reduce the costs of said battery systems, it is therefore necessary to improve the monitoring of the temperature-control system.

### SUMMARY OF THE INVENTION

The inventive devices and methods have the advantage that the temperature-control medium flow monitors the cooling system, and faults or defects in said cooling system, such as blockages, component defects or leakages can be detected and signaled. As a result, the susceptibility to failure, reliability and disposability of energy stores or respectively battery systems can be improved. In addition, flow sensors can be eliminated. As a result, the design of the battery system can be simplified and the number of components of the battery system can be reduced. Hence, the susceptibility to failure can be further lowered. Furthermore, the costs, for example manufacturing costs, service costs or maintenance costs can be reduced and resources can be saved.

In an advantageous manner, the temperature threshold value can correspond to a predetermined maximum temperature value. In so doing, a maximum admissible operating temperature of the energy store can be maintained. Thus, the dependability and the service life of the battery cells can be increased.

In an expedient manner, the temperature threshold value can be determined or codetermined by means of an average temperature value from the plurality of average temperature values. The battery cells of the energy store can thereby be compared with one another while taking into account the age thereof and the current load thereon. A provision and storage of predetermined reference values can furthermore be eliminated.

In an expedient manner, the apparatus for determining can be designed as a decentralized pre-processing apparatus. As a result, the transmission of values and the stress on the central processing apparatus can be reduced. In addition, the number of connection lines can be reduced.

In an expedient manner, the apparatus for determining and/or the apparatus for evaluating and determining can be designed as a central processing apparatus. As a result, the complexity of the monitoring device can be reduced. In addition, the flexibility and maintainability of the monitoring device can be increased.

In an expedient manner, the battery groups can be designed as partial batteries, battery strings or battery modules. In so doing, the monitoring device can be adapted to the design of the energy store.

The invention provides a battery system which comprises the previously described device.

The invention further provides a vehicle, in particular a motor vehicle such as an electric vehicle, hybrid vehicle or electric motor bike (electric bike, E-bike), electric bicycle (pedal electric cycle, pedelec), a nautical vessel such as an electric boat or submarine (sub), an aircraft or a spacecraft, which comprises the device previously described and associated with the vehicle or the battery system previously described and associated with the vehicle.

In an expedient manner, the temperature threshold value can correspond to a predetermined maximum temperature value. In this way, a maximum admissible operating temperature of the energy store can be maintained. In this way, the dependability and service life of the battery cells can be increased.

In an expedient manner, the temperature threshold value can be determined or codetermined by means of an average temperature value from the plurality of average temperature values. As a result, the battery cells of the energy store can be compared with one another while taking into account the age thereof and the current load thereon. In addition, a provision and storage of predetermined reference values can be eliminated.

In an expedient manner, the apparatus for determining can be designed as a decentralized pre-processing apparatus. As a result, the transmission of values and the stress on the central processing apparatus can be reduced. In addition, the number of connection lines can be reduced.

In an expedient manner, the apparatus for determining and/or the apparatus for evaluating and determining can be designed as a central processing apparatus. As a result, the complexity of the monitoring device can be reduced. In addition, the flexibility and maintainability of the monitoring device can be increased.

In an expedient manner, the battery groups can be designed as partial batteries, battery strings or battery modules. In so doing, the monitoring device can be adapted to the design of the energy store.

The invention furthermore provides a computer program which is stored on a data carrier or in a memory of a computer and which comprises commands that can be read by the computer and are provided to carry out one of the previously described methods if the commands are executed on a computer.

The invention furthermore provides for a computer program product which comprises the previously described computer program.

It is within the scope of the invention for the steps of the method to not necessarily be carried out in the described sequence. In a further embodiment, the steps of the method can also be nested within one another (interleaving).

It is furthermore possible for individual sections of the described method to be able to be designed as individual saleable units and for the remaining sections of the method to be able to be designed as other saleable units. The method according to the invention can therefore be carried out as a distributed system on different computer-based entities, for example client/server entities. Hence, it is, for example, possible that a module for itself comprises different sub-modules.

### BRIEF DESCRIPTION OF THE DRAWINGS

Exemplary embodiments of the invention are depicted in the drawings and are explained in detail in the following description.

In the drawings:

FIG. 1 shows a schematic view of an energy store 10 according to the prior art;

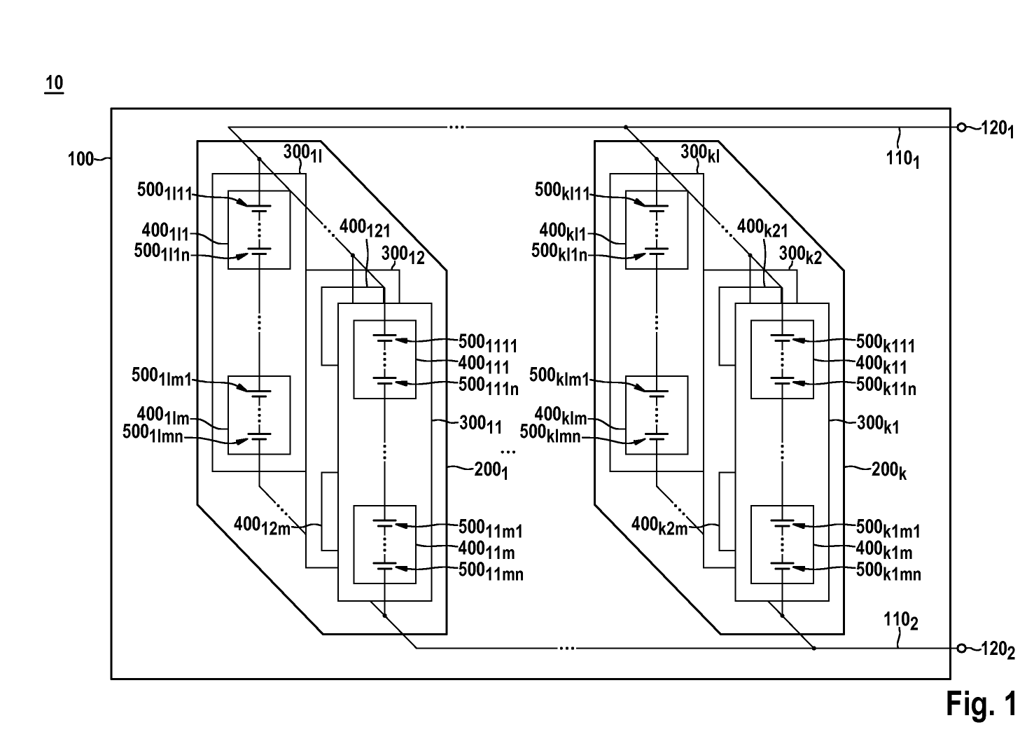

FIG. 2 shows a schematic view of an energy store 20 according to one embodiment of the invention;

FIG. 3 shows a schematic view of an energy store 30 according to another embodiment of the invention;

FIG. 4 shows an exemplary temporal temperature profile during a partial breakdown according to the embodiments of the invention; and

FIG. 5 shows an exemplary temporal temperature profile during a total breakdown according to the embodiments of the invention.

### DETAILED DESCRIPTION

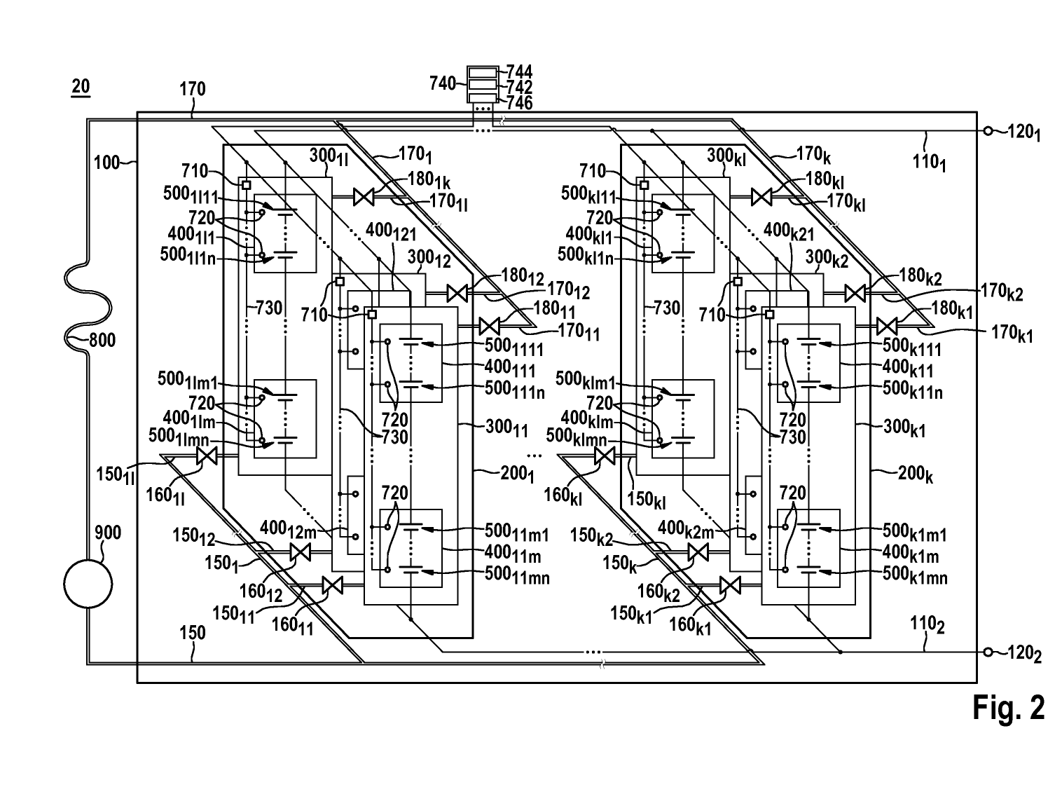

FIG. 2 shows a schematic view of an energy store 20 according to one embodiment of the invention.

The energy store or respectively the battery system comprises a plurality of battery cells 500₁₁₁₁ to 500ₖₗₘₙ. Each battery cell can, for example, have a voltage of 4.5 V and a capacity of 60-75 Ah. The plurality of battery cells 500₁₁₁₁ to 500ₖₗₘₙ is arranged in a plurality of battery modules 400₁₁₁ to 400ₖₗₘₙ, so that each battery module comprises n battery cells. Each battery module can, for example, comprise n=11 to 13 battery cells that are connected in series and therefore have a voltage of 50-60 V and a capacity of 60-75 Ah. The plurality of battery modules 400₁₁₁ to 400ₖₗₘ is arranged in a plurality of battery strings 300₁₁ to 300ₖₗ, so that each battery string comprises m battery modules. Each battery string can, for example, comprise m=13 to 20 battery modules which are connected in series and thus have a voltage of 640-1170 V and a capacity of 60-75 Ah. The plurality of battery strings 300₁₁ to 300ₖₗ is arranged in a plurality of partial batteries 200₁ to 200ₖ so that each partial battery comprises I battery strings. Each partial battery can, for example, can, for example, I=80 battery strings which are connected in parallel and thus have a voltage of 640-1170 V and a capacity 4800-6000 Ah. The plurality of partial batteries 200₁ to 200ₖ is arranged as a battery 100 so that the battery k comprises partial batteries. The battery 100 can, for example, comprise k=2 to 4 partial batteries that are connected in parallel and thus have a voltage of 640-1170 V and a capacity of 9600-24000 Ah and comprise in total 22800-374400 battery cells. The battery 100 comprises lines 110₁, 110₂ for connecting the partial batteries 200₁ to 200ₖ; thus enabling the electrical energy to be available at connections 120₁, 120₂.

The battery cells 500₁₁₁₁ to 500ₖₗₘₙ can be prismatic, for example ashlar-formed, and each comprise a cell housing and a cell cover having in each case two electrical cell connections, for example made of aluminum or copper. The electrical cell connections can each, for example, comprise a threaded hole for the purpose of electrical connection. In order to electrically connect the battery cells 500₁₁₁₁ to 500ₖₗₘₙ to the battery modules ₄₀₀₁₁₁ to 400ₖₗₘₙ, connection pieces, for example cell connectors, for example made of aluminum or copper, can be used which electrically connect the cell connections of the battery cells 500₁₁₁₁ to 500ₖₗₘₙ to one another according to the respective requirement. In order to manufacture a battery module ₄₀₀₁₁₁ to 400ₖₗₘₙ, the connection pieces can, for example, be welded to the cell connections, for example by means of a laser, in accordance with the spatial orientation of the battery cells 500₁₁₁₁ to 500ₖₗₘₙ.

The battery cells 500₁₁₁₁ ^{to 500}ₖₗₘₙ can be designed as primary cells or respectively primary elements which are not rechargeable or as secondary elements which are rechargeable. The secondary cells can, for example, be designed as a lithium-ion battery (lithium battery, lithium-ion battery, Li-ion battery, Li-ion secondary battery) or as a lithium-polymer accumulator (Li-poly battery, LiPo battery). The battery cells 500₁₁₁₁ to 500ₖₗₘₙ can be designed comprising an electrode coil (jelly roll, JR, Swiss roll), for example as a lithium-ion battery comprising an electrode coil (JR-Li-ion battery). The battery cells 500₁₁₁₁ to 500ₖₗₘₙ, can be designed as a pouch cell. In so doing, a pouch, which is used to receive and accommodate an electrolyte, can comprise one, two, three or more electrode coils. In addition, a protective envelope can enclose the pouch or pouches. The protective envelope can comprise a resistant (shock-proof, bulletproof, ballistic, anti-ballistic) material, for example ballistic fabric, such as ballistic polyamide fabric (ballistic nylon fabric, ballistic nylon). Hence, the electrode coils can be protected against damage from the outside, for example in the event of an accident, and/or in the event of a thermal runaway of an electrode coil, which can exert considerable force on adjacent battery cells.

The energy store 20 further comprises a temperature-control device for controlling the temperature, i.e. cooling or heating, of the battery cells 500₁₁₁₁ to 500ₖₗₘₙ by means of a temperature-control medium, for example a liquid like alcohol, for example propane-1,2,3-triol (glycerol, glycerin), oil or water, for example salt water or a liquid mixture. A cooling agent such as a coolant (air-heat radiator) or a refrigerant which evaporates due to the heat (evaporator) can, for example, absorb the heat of the battery cells 500₁₁₁₁ to 500ₖₗₘₙ and discharge said heat via a radiator or heat exchanger 800 to the surrounding environment or to an air conditioning system (AC). The temperature control device comprises heat exchangers for exchanging the heat between the battery cells 500₁₁₁₁ to 500ₖₗₘₙ and the temperature-control medium that flows through the temperature-control device. The heat exchangers can, for example, be designed as cooling plates. Each battery module 400₁₁₁ to 400ₖₗₘ, can, for example, comprise a cooling plate or a plurality of cooling plates. The battery cells 500₁₁₁₁ to 500ₖₗₘₙ can be mounted on the cooling plates.

The temperature-control device further comprises connection devices such as inflow lines 150, 150₁-150ₖ, 150₁₁-150ₖₗ and outflow lines 170, 170₁-170ₖ for connecting the components of the temperature-control device. The connection devices can be designed as tubes and/or pipes and comprise, for example, plastic or metal such as aluminum, iron or steel. As is shown by way of example in FIG. 2, the inflow of the temperature-control medium in the direction of the battery cells 500₁₁₁₁ to 500ₖₗₘₙ can, for example, take place via a main inflow line 150, partial battery inflow lines 150₁-150ₖ, which branch off from the main inflow line 150 and battery string inflow lines 150₁₁-150ₖₗ, which in each case branch off from the partial battery inflow lines 150₁-150ₖ. After the heat exchange with the battery cells 500₁₁₁₁ to 500ₖₗₘₙ, the outflow of the temperature-control medium, as shown by way of example in FIG. 2, can take place via battery string outflow lines 170₁₁-170ₖₗ, which each open into partial battery outflow lines 170₁-170ₖ that open into a main outflow line 170.

The temperature-control device can furthermore comprise actuating devices for blocking and/or controlling the temperature-control medium flow. The actuating devices can, for example, be designed as shut-off devices such as shut-off cocks, shut-off valves or shut-off slides or as valves such as manually actuated valves, electromotively actuated valves or electromagnetic valves. The inflows of the temperature-control medium in the direction of the battery cells 500₁₁₁₁ to 500ₖₗₘₙ can, for example, as shown by way of example in FIG. 2, be discretely or respectively individually controlled by means of battery string inflow valves 160₁₁-160ₖₗ which in each case are disposed in battery string inflow lines 150₁₁-150ₖₗ. After the heat exchange with the battery cells 500₁₁₁₁ to 500ₖₗₘₙ, the outflows of the temperature-control medium, as shown by way of example in FIG. 2, can be discretely or respectively individually controlled by means of battery string outflow valves 180₁₁-180ₖₗ, which are disposed in each case in the battery string outflow lines 170₁₁-170ₖₗ. In order to control or shut-off the flow, the inflow valves 160₁₁-160ₖₗ and the respectively corresponding outflow valves 180₁₁-180ₖₗ can be controlled in pairs.

The temperature-control device can comprise the heat exchanger 800 which is connected to the main inflow line 150 and the main outflow line 170; thus enabling the temperature-control device to have a (closed) temperature-control medium circuit. The temperature-control device can furthermore comprise a delivery apparatus 900 such as a pump that is connected to the main inflow line150 or to the main outflow line 170; thus enabling the temperature-control medium flow to be reinforced or controlled.

The energy store 20 further comprises a monitoring device for monitoring the energy store 20 and the battery cells 500₁₁₁₁ to 500ₖₗₘ. The monitoring device comprises a plurality of sensor apparatuses 720 for sensing temperature measurement values of the battery cells 500₁₁₁₁ to 500ₖₗₘₙ and a processing apparatus 740 for processing the sensed temperature measurement values. The processing apparatus 740 can comprise an interface 746 for transmitting or receiving the sensed temperature measurement values, a store 744 such as a read-write memory (random access memory, RAM) for storing the received temperature measurement values and a processor such as a microprocessor or microcontroller for processing the stored temperature measurement values by means of the stored commands. The sensor apparatuses 720 are disposed in such a way that said apparatuses can sense the temperatures of the battery cells 500₁₁₁₁ to 500ₖₗₘₙ and are connected via lines 730, directly or indirectly, to the interface 760. A sensor apparatus 720 is preferably associated with each battery cell 500₁₁₁₁ to 500ₖₗₘₙ; thus enabling the temperature of each battery cell 500₁₁₁₁ to 500ₖₗₘₙ to be sensed.

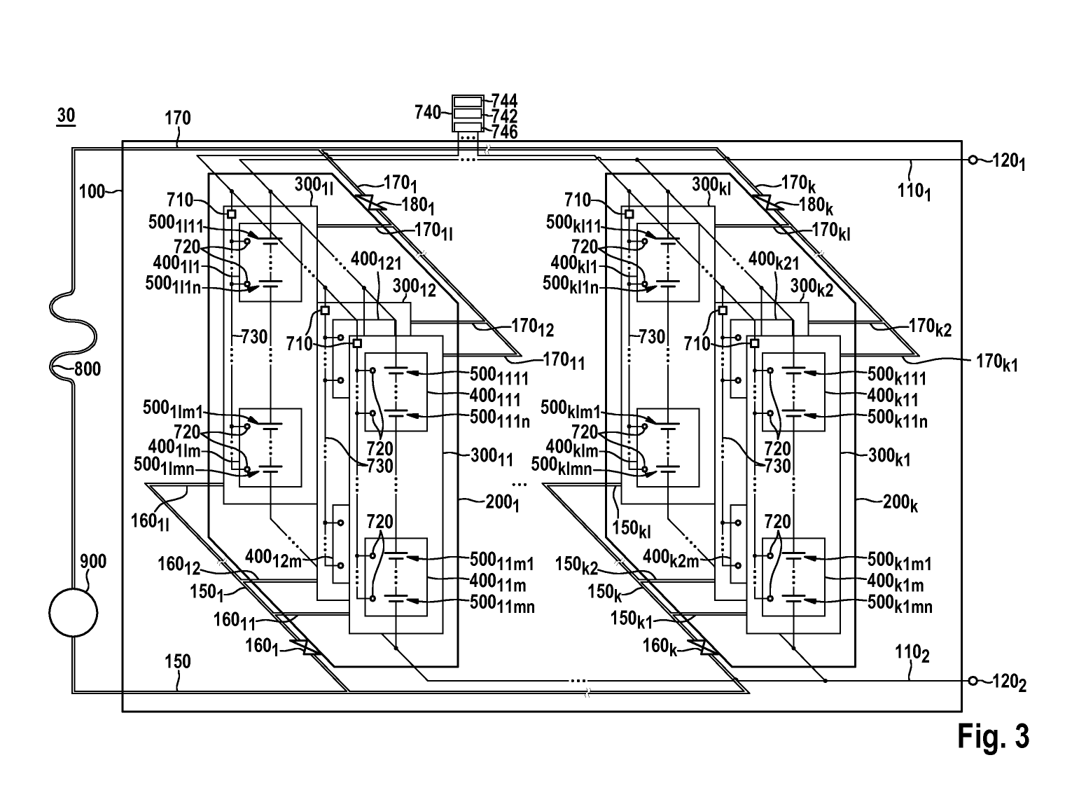

The monitoring device can further comprise a plurality of pre-processing apparatuses for pre-processing the sensed temperature measurement values, a number of the plurality of sensor apparatuses 720 being associated with each pre-processing apparatus 710. The pre-processing apparatuses 710 can, as is shown by way of example in FIG. 3, each be associated with a battery string 300₁₁-300ₖₗ. Alternatively, the pre-processing apparatuses 710 can each be associated with a battery module 400₁₁₁-400ₖₗₘₙ or a partial battery 200₁-200ₖ. The pre-processing apparatuses 710 are however associated in accordance with the structure of the inflow lines 150, 150₁-150ₖ, 150₁₁-150ₖₗ and/or outflow lines 170, 170₁-170ₖ; thus enabling the battery cells 500₁₁₁₁ to 500ₖₗₘₙ associated with the number of sensor apparatuses 720 to be temperature-controlled by a (partial) flow of the temperature-control medium. The pre-processing apparatuses 710 can, similar to the pre-processing apparatus 740, process temperature measurement values sensed by the number of associated sensor apparatuses 720; thus enabling the pre-processing of all of the sensed temperature measurement values to be parallelized and/or the transmission of the temperature measurement values to be simplified. An averaging can, for example, already take place in the respective pre-processing apparatuses 710. A monitoring method can thus be carried out distributed over the processing apparatus 740 and the plurality of pre-processing apparatuses 710.

A monitoring method for monitoring the energy store 20, in particular the temperature thereof, and therefore also the temperature-control device of said energy store comprises initially a sensing of the temperatures of each battery cell 500₁₁₁₁ to 500ₖₗₘₙ by means of the sensor apparatuses 720 as sensed temperature measurement values and if need be a repetition of the sensing. The monitoring method can further comprise selecting temperature measurement values from the sensed temperature measurement values. The monitoring method can further comprise determining average temperature values (averaging) in each case from the selected temperature measurement values, wherein the selected temperature measurement values can in each case be associated with a group of battery cells 500₁₁₁-500ₖₗₘ(battery group), such as a partial battery 200₁-200ₖ, a battery string 300₁₁-300ₖₗ or a battery module 400₁₁₁-400ₖₗₙₘ, so that the average temperature values for each partial battery 200₁-200ₖ (partial battery average temperature), each battery string 300₁₁-300ₖₗ (battery string average temperature) and/or each battery module 400₁₁₁-400ₖₗₘₙ (battery module average temperature) can be determined. The monitoring method can furthermore comprise determining of temperature maximum values in each case from the selected temperature measurement values, wherein the selected temperature can in each case be associated with a partial battery 200₁-200ₖ, a battery string 300₁₁-300ₖₗ or a battery module 400₁₁₁-400ₖₗₘₙ , thus enabling the temperature maximum values to be determined for each partial battery 200₁-200ₖ (partial battery maximum temperature), each battery string 300₁₁-300ₖₗ (battery string maximum temperature) and/or each battery module 400₁₁₁-400ₖₗₘₙ (battery module maximum temperature). The monitoring method can accordingly comprise determining temperature minimum values in each case from the selected temperature measurement values. Determining the average temperature value from the selected temperature measurement values, determining the temperature maximum values and/or determining the temperature minimum values preferably takes place in each case by means or the pre-processing apparatuses 710.

The monitoring method can furthermore comprise determining an average temperature value (averaging) from the determined average temperature values, i.e. from the partial battery average temperatures, the battery string average temperatures or the module average temperatures. The monitoring method can furthermore comprise determining a maximum average temperature value from the average temperature values; thus enabling the maximum partial battery average temperature (the “hottest” partial battery), the maximum battery string average temperature (the “hottest” battery string) or the maximum battery module average temperature (the “hottest” battery module) to be determined. The monitoring method can furthermore comprise determining a minimum average temperature value from the determined average temperature values; thus enabling the minimum partial battery average temperature value (the “coolest” partial battery), the minimum battery string average temperature (the “coolest” battery string) or the minimum battery module average temperature (the “coolest” battery module) to be determined. Determining the average temperature value, the maximum average temperature value and/or the minimum average temperature value from the determined average temperature values takes place preferably by means of the processing apparatus 740.

The monitoring method can furthermore comprise comparing the determined average temperature values to one another or respectively among one another. As a result, this comparing of the determined average temperature values can comprise comparing the determined average temperature values to the determined average temperature value (of the determined average temperature values). If the comparison of the determined average temperature values with one another results in a significant difference of one of the determined average temperature values, the monitoring method can recognize a defect of the temperature-control device, the position of which corresponds to the different determined average temperature value, in particular if the charging or respectively discharging of the energy store 20 takes place within the scope of the electrical specification.

The monitoring method can furthermore comprise a comparison of the determined average temperature values, the determined average temperature value and/or the maximum average temperature value with a predetermined temperature value Tₖ, which corresponds to the critical operating temperature of the energy store 20, and an outputting of a command for the maximum operation of the temperature-control device. The comparison and output of the command for maximum operation preferably takes place by means of the processing apparatus 740.

The monitoring method can furthermore comprise a comparison of the determined average temperature values, the determined average temperature value and/or the maximum average temperature value with a predetermined maximum temperature value Tₘₐₓ, which corresponds to the maximally admissible operating temperature of the energy store 20, and an outputting of a command to deactivate the energy store 20. If the comparison of the determined average temperature values or the determined average temperature value with the predetermined maximum temperature value Tₘₐₓ results in the maximum temperature value T. being exceeded, the monitoring method can detect a defect of the temperature-control device, for example along the inflow lines 150, 150₁, 150₁₁-150ₖₗ and the main flow line 170, 170₁, 170₁₁-170ₖₗ, in particular if the charging or discharging of the energy store takes place within the scope of the electrical specification. A determined battery string average temperature of the battery string 300₁₂ being exceeded can, for example, identify or respectively detect and signal a blockage of the battery string inflow line 150₁₂ or respectively the battery string outflow line 170₁₂ or a breakdown of the inflow valve 160₁₂ or respectively outflow valve 180₁₂ in a closed position. A determined partial battery average temperature of the partial battery 200ₖ being exceeded can correspondingly identify or respectively detect and signal a blockage of the partial battery inflow line 150ₖ or respectively the partial battery outflow line 170ₖ. In addition, a plurality of determined average temperature values being jointly exceeded, for example of determined battery string average temperatures of the battery strings 300₁₂-300₁₁, can identify or respectively detect a blockage of the partial battery inflow line 150₁ and limit said blockage to a section between the battery string inflow lines 150₁₁ and 150₁₂ because the determined battery string average temperature of the battery string 300₁₁ not being exceeded signals a free partial battery outflow line 170₁. The comparison and outputting of the command for deactivation preferably takes place by means of the processing apparatus 740.

FIG. 3 shows a schematic view of an energy store 30 according to another embodiment of the invention.

The energy store 30 shown in FIG. 3 corresponds substantially to the energy store 20 described with reference to FIG. 2. The inflows of the temperature-control medium in the direction of the battery cells 500₁₁₁₁ to 500ₖₗₘₙ can, as shown by way of example in FIG. 3, be controlled by means of partial battery inflow valves 160₁-160ₖ which are disposed in the partial battery inflow lines 150₁-150ₖ. After the heat exchange with the battery cells 500₁₁₁₁ to 500ₖₗₘₙ, the outflows of the temperature-control medium, as shown by way of example in FIG. 3, can be controlled by means of partial battery outflow valves 180₁-180ₖ which are disposed in the partial battery outflow lines 170₁-170ₖ.

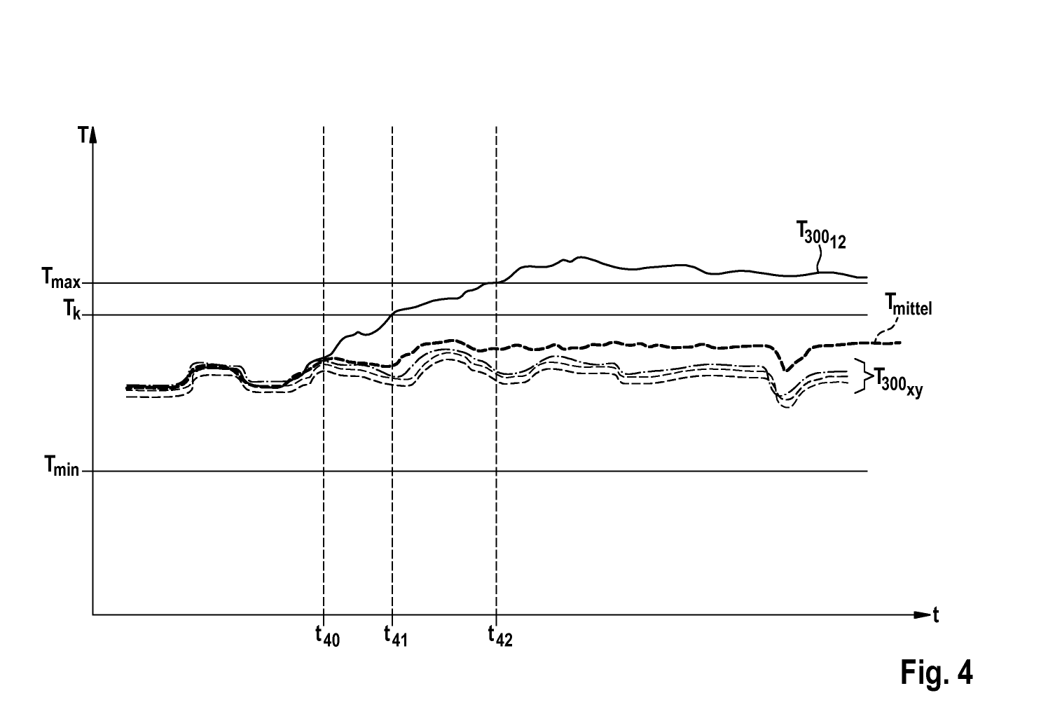

FIG. 4 shows an exemplary temporal temperature profile during a partial breakdown according to the embodiments of the invention.

The points in time t₄₀ to t₄₂ are marked along a horizontal time axis t. An admissible temperature range comprising a predetermined minimum temperature Tₘᵢₙ, for example +25° C., and a predetermined maximum temperature Tₘₐₓ, for example +40° C., and a critical temperature Tₖ, for example +35° C., for activating the maximum operation of the temperature-control device are marked along a vertical temperature axis T. Certain battery string average temperatures T₃₀₀₍₁₂₎, T_{300(xy)} of the battery strings 300₁₂-300ₖₗ of the energy store depicted in FIG. 2 and the average temperature value Tₘᵢₜₜₑₗ obtained therefrom are plotted by way of example in the temporal profile.

A defect occurs in the temperature control device with regard to the battery string 300₁₂ at the point in time t₄₀, for example a blockage of the battery string inflow line 150₁₂ or the battery string outflow line 170₁₂ or a breakdown of the inflow valve 160₁₂ or the outflow valve 180₁₂ in a closed position. As a result of the partial breakdown of the cooling process, the determined battery string average temperature T₃₀₀₍₁₂₎ of the battery string 300₁₂ and thereby also proportionally the determined average temperature value Tₘᵢₜₜₑₗ increase.

The determined battery string average temperature T₃₀₀₍₁₂₎ of the battery string 300₁₂ reaches the critical temperature Tₖ at the point in time t₄₁, and the monitoring device induces the maximum operation of the temperature-control device. The determined battery string average temperature T₃₀₀₍₁₂₎ of the battery string 300₁₂ and also the determined average temperature value Tₘᵢₜₜₑₗ continue to rise.

The determined battery string average temperature T₃₀₀₍₁₂₎ of the battery string 300₁₂ reaches the maximum temperature Tₘₐₓ at the point in time t₄₂, and the monitoring device induces a deactivation of the energy store 20. Prior to this event or alternatively, the monitoring device can deactivate the affected battery string 300₁₂.

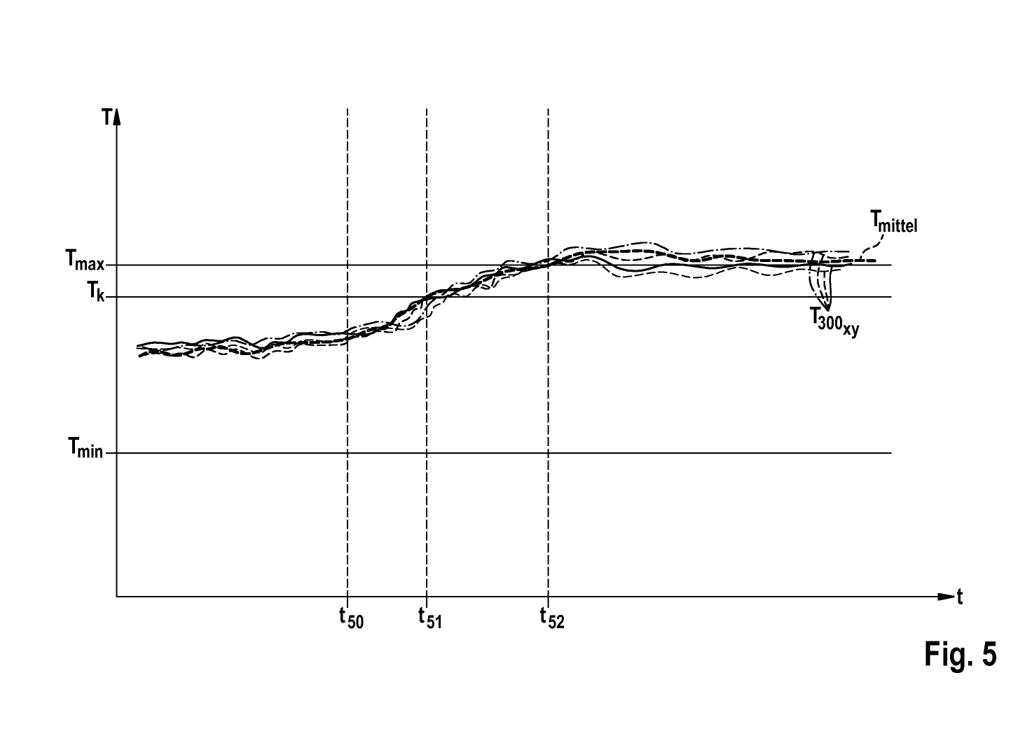

FIG. 5 shows an exemplary temporal temperature profile when a total breakdown occurs pursuant to the embodiments of the invention.

The points in time t₅₀ to t₅₂ are marked along a horizontal time axis t. The admissible temperature range, comprising the predetermined minimum temperature Tₘᵢₙ and the predetermined maximum temperature Tₘₐₓ, and the critical temperature Tₖ are marked along a vertical temperature axis T, as was already described with regard to FIG. 4. Certain battery string average temperatures T_{300(xy)} of the battery strings 300₁₂-300ₖₗ of the energy store depicted in FIG. 2 and the average temperature value Tₘᵢₜₜₑₗ obtained therefrom are plotted by way of example in the temporal profile.

For example, a blockage of the battery inflow line 150 or the battery outflow line 170 or a breakdown of the pump 900 occurs in the temperature-control device at the point in time t₅₀. As a result of the of the total breakdown of the cooling process, the determined battery string average temperatures T_{300(xy)} of the battery strings 300₁₂-300ₖₗ and thereby also the determined average temperature value Tₘₐₜₜₑₗ rise.

The determined battery string average temperatures T_{300(xy)} of the battery strings 300₁₂-300ₖₗ or respectively the determined average temperature value Tₘᵢₜₜₑₗ reach the critical temperature Tₖ at the point in time t₅₁, and the monitoring device induces the maximum operation of the temperature-control device. The determined battery string average temperatures T_{300(xy)} of the battery strings 300₁₂-300ₖₗ and also the determined average temperature value Tₘᵢₜₜₑₗ continue to rise.

The determined battery string average temperatures T_{300(xy)} of the battery strings 300₁₂-300ₖₗ or respectively the average temperature value Tₘᵢₜₜₑₗ reach the maximum temperature Tₘₐₓ at the point in time t₅₂, and the monitoring device induces a deactivation of the energy store 20.

The features of the energy store 20; 30, for example of the valves shown in FIGS. 2 and 3, can be combined with one another.

1. A device (710, 720, 730, 740) for monitoring an energy store (20; 30) comprising a plurality of battery cells (500₁₁₁₁-500ₖₗₘₙ), which are arranged in a plurality of battery groups (200₁-200ₖ, 300₁₁-300ₖₗ, 400₁₁₁-400ₖₗₘ), and a temperature-control device for controlling the temperature of the battery cells (500₁₁₁₁-500ₖₗₘₙ) by means of a plurality of partial flows of a temperature-control medium, each of the partial flows being associated with one of the battery groups (200₁-200ₖ, 300₁₁-300ₖₗ, 400₁₁₁-400ₖₗₘ), characterized by:
a plurality of sensor apparatuses (720), the plurality of sensor apparatuses (720) sensing temperature measurement values of the battery cells (500₁₁₁₁-500ₖₗₘ), each of the sensor apparatuses (720) being arranged such that the sensor apparatus senses the temperature measurement value of one of the battery cells (500₁₁₁₁-500ₖₗₘₙ);
a determination apparatus (710, 740) which determines a plurality of average temperature values from the sensed temperature measurement values, each of the determined average temperature values being determined in such a way that the determined average temperature value is associated with one of the battery groups (200₁-200ₖ, 300₁₁-300ₖₗ, 400₁₁₁-400ₖₗₘ); and
an evaluation apparatus (740) which evaluates the plurality of determined average temperature values and, if one of the determined average temperature values exceeds a temperature threshold value, determines that the partial flow associated with the associated battery group (200₁-200ₖ, 300₁₁-300ₖₗ, 400₁₁₁-400ₖₗₘ) has a fault.

2. The device (710, 720, 730, 740) according to claim 1, wherein:
the temperature threshold value corresponds to a predetermined maximum temperature value.

3. The device (710, 720, 730, 740) according to claim 1, wherein:
the determining apparatus (710, 740) is configured as a decentralized pre-processing apparatus (710); or as a central processing apparatus (740); or
the evaluation apparatus (740) configured as a central processing apparatus (740).

4. The device (710, 720, 730, 740) according to claim 1, wherein:
the battery groups (200₁-200ₖ, 300₁₁-300ₖₗ, 400₁₁₁-400ₖₗₘ) are configured as partial batteries (200₁-200ₖ), battery strings (300₁₁-300ₖₗ) or battery modules (400₁₁₁-400ₖₗₘ).

5. An energy store (20; 30)
including the device (710, 720, 730, 740) according to claim 1.

6. Vehicle, motor vehicle, electric motor vehicle or hybrid vehicle,
including the device (710, 720, 730, 740) according to claim 1 associated with the vehicle.

7. A method for monitoring an energy store (20; 30) comprising a plurality of battery cells (500₁₁₁₁-500ₖₗₘₙ) arranged in a plurality of battery groups (200₁-200ₖ, 300₁₁-300ₖₗ, 400₁₁₁-400ₖₗₘ), and a temperature-control device which controls the temperature of the battery cells (500₁₁₁₁-500ₖₗₘₙ) by plurality of partial flows of a temperature-control medium, each of the partial flows being associated with one of the battery groups (200₁-200ₖ, 300₁₁-300ₖₗ, 400₁₁₁-400ₖₗₘ), characterized by:
sensing temperature measurement values of the battery cells (500₁₁₁₁-500ₖₗₘₙ) by a plurality of sensor apparatuses (720), each of the sensor apparatuses (720) arranged such that the sensor apparatuses sense the temperature measurement value of one of the battery cells (500₁₁₁₁-500ₖₗₘₙ);
determining a plurality of average temperature values from the sensed temperature measurement values by a first apparatus (710, 740), each of the determined average temperature values being determined such that the determined average temperature value is associated with one of the battery groups (200₁-200ₖ, 300₁₁-300ₖₗ, 400₁₁₁-400ₖₗₘ); and
evaluating, using a second apparatus (740), the plurality of determined average temperature values and, if one of the determined average temperature values exceeds a temperature threshold value, determining that the partial flow associated with the associated battery group (200₁-200ₖ, 300₁₁-300ₖₗ, 400₁₁₁-400ₖₗₘ) has a fault.

8. The method according to claim 7, wherein;
the temperature threshold value corresponds to a predetermined maximum temperature value.

9. The method according to claim 7, wherein:
the apparatus (710, 740) for determining a plurality of average temperature values-from the sensed temperature measurement values is configured as a decentralized pre-processing apparatus (710);
the apparatus (710, 740) for determining a plurality of average temperature values from the sensed temperature measurement values is configured as a central processing apparatus (740); or
the apparatus (740) for evaluating and determining the plurality of determined average temperature values is configured as a central processing apparatus (740).

10. The method according to claim 7, wherein:
the battery groups (200₁-200ₖ, 300₁₁-300ₖₗ, 400₁₁₁-400ₖₗₘ) are configured as partial batteries (200₁-200ₖ), battery strings (300₁₁-300ₖₗ) or battery modules (400₁₁₁-400ₖₗₘ).

11. A non-transitory computer readable medium including a computer program which comprises commands that can be read by the computer (710, 740) and are specified for carrying out the method according to claim 7 if the commands are executed on the computer (710, 740).

12. (canceled)

13. The device (710, 720, 730, 740) according to claim 1, wherein:
the temperature threshold value is determined or co-determined by an average temperature value from the plurality of average temperature values.

14. Vehicle, motor vehicle, electric motor vehicle or hybrid vehicle, including the battery system according to claim 5 associated with the vehicle.

15. The method according to claim 7, wherein;
the temperature threshold value is determined or co-determined by an average temperature value from the plurality of average temperature values.

16. The non-transitory computer readable medium according to claim 11, wherein the medium is a data carrier.

17. The non-transitory computer readable medium according to claim 11, wherein the medium is a memory (744).
